(19) United States
(12) Patent Application Publication
(10) Pub. No.: US 2005/0238368 A1
(43) Pub. Date: Oct. 27, 2005

(54) Driving circuit for optical modulator and method for driving optical modulator

(75) Inventors: Tadashi Ikeuchi, Kawasaki (JP); Naoki Kuwata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/041,218

(22) Filed: Jan. 25, 2005

Related U.S. Application Data
(63) Continuation of application No. PCT/JP02/13123, filed on Dec. 16, 2002.

(51) Int. Cl. H04B 10/04

(52) U.S. Cl. 398/198

(57) ABSTRACT

For an optical modulator for modulating input light using a clock signal and a data signal respectively, a pulse width varying circuit varies the pulse width of the data signal that is used for modulating the input light, and a delay control section carries out controls based on the light output power of the optical modulator in this state in such a manner that the phase difference between the clock signal and the data signal becomes minimum. As a result, it is possible to always adjust phases of the clock signal and the data signal to optimum phases and to stably obtain a fine light output waveform.

### CROSS REFERENCE TO RELATED APPLICATIONS

This application is based on and hereby claims priority to International Application No. PCT/JP2002/013123 filed on Dec. 16, 2002 in Japan, the contents of which are hereby incorporated by reference.

### BACKGROUND OF THE INVENTION

1) Field of the Invention

The present invention relates to a driving circuit for an optical modulator and a method for driving an optical modulator, and particularly relates to a driving circuit preferably for a Mach-Zehnder optical modulator that is used for an optical transmitter that transmits an RZ (Return to Zero) signal and a driving method therefor.

2) Description of the Related Art

An accompanying drawing FIG. 18 is a block diagram schematically showing a conventional Mach-Zehnder optical modulator for generating an RZ signal and the main part of a driving circuit therefor. The Mach-Zehnder optical modulator shown in FIG. 18 is used in an optical transmitter that transmits an RZ signal, and includes a Mach-Zehnder optical modulator (hereinafter called a clock modulator) 100 for a clock signal, a Mach-Zehnder optical modulator (hereinafter called a data modulator) 200 for a data signal, a variable delay circuit 300 and amplifiers 400 and 500.

Here, the clock modulator 100 receives input light form a light source (not shown) exemplified by a laser from or the like and modulates the input light using a clock (CLK) signal (an RZ signal) that is supplied through the variable delay circuit 300 and the amplifier 400. Specifically, application of a clock signal voltage to one of electrodes 101 varies the index of optical refraction of the portion so that the phase of one of the input light beams which has been obtained by division at an input-side Y optical waveguide 101 is shifted. As a result, the divided input light beam interferes with the other divided input light beam (to intensify/weaken resultant output light) at an output-side Y optical waveguide 103 and an optical clock signal (light flashing) is thereby generated.

The data modulator 200 further modulates the optical clock signal, which has been obtained by the clock modulator 100, using a data (DATA) signal (an NRZ (Non-Return to Zero) signal) in the same manner as the above clock modulator 200 in which application of a data signal voltage to one of electrodes 202 varies the index of optical refraction of the portion so that the phase of one of the input light beams which has been obtained by division at an input-side Y optical waveguide 201 is shifted. As a result, the divided input light beam interferes with the other divided input light beam (to intensify/weaken resultant output light) at an output-side Y optical waveguide 203.

In other words, the optical modulator shown in FIG. 18 modulates input light in the clock modulator 100, using a clock signal, to generate an optical clock signal and further modulate the optical clock signal in the data modulator 200, using a data signal, to thereby impose the data signal on the optical clock signal.

For this purpose, the phases of the clock signal and the data signal should be optimum phases, i.e., the cross points of the data signal should coincide with the extinction time points of the clock signal. As a solution of a conventional technique, the variable delay circuit 300 is, for example, arranged on the clock signal line (or the data signal line) so that the phase difference between the clock signal and the data signal is adjusted (set) to an optimum phase. Alternatively, with the absence of the variable delay circuit 300, lengths of the clock signal line and the data signal line may be previously adjusted such that the phase between the clock signal and the data signal becomes optimum (phases).

As a result, the phase between the clock signal and the data signal is set to an optimum phase and a fine light output waveform can be obtained. In FIG. 18, the reference numbers 400 and 500 represent amplifiers for amplifying a clock signal and a data signal to predetermined levels respectively.

In order to keep up with recent high-speed transmission signals, such a conventional optical modulator, however, has to adjust a phase between the clock signal and the data signal with high accuracy because of a shortened time slot (for example, one time slot of a transmission signal of 40 Gb/s corresponds to 7.5 mm in a vacuum), resulting in increased costs. Fluctuation in a delay amount of a clock signal or a data signal because of operation over time causes degradation of a light output waveform so that transmission characteristics also deteriorate.

A technique to optimize the relative phase between a data signal and an optical pulse train of public knowledge is disclosed in Japanese Patent Application Laid-open No. HEI 9-181683. In the disclosed technique, as shown in FIG. 1 thereof, an optical coupler splits a part of an output optical pulse train from a data modulator, which modulates an incident optical pulse train using a data signal synchronizing with a clock signal, and inputs the split part of the output optical pulse train to an electro-absorption modulator, which detects the phase of the split part of the output optical pulse train in the form of a modulation optical electric current, and a controller controls a shift amount of a phase of the variable phase unit based on the modulation optical electric current so that a relative phase between (the phase of) the data signal and the incident optical pulse train is optimized.

The disclosed technique, however, utilizes an expensive electro-absorption modulator that detects the phase of an output optical pulse train, resulting in greatly increased costs.

With the foregoing problems in view, the object of the present invention is, in an optical modulator for modulating input light using a clock signal and a data signal respectively, to accurately optimize phases of a clock signal and a data signal in a simple configuration.

### SUMMARY OF THE INVENTION

In order to attain the above object, there is provided a driving circuit for an optical modulator comprising: a variable delay circuit for adjusting a phase difference between a clock signal and a data signal; a pulse width varying circuit for varying a pulse width of the data signal used for modulating input light; and a delay controlling section for controlling the variable delay circuit based on light output power of the optical modulator in a state that the pulse width varying circuit varies the pulse width in such a manner that the phase difference becomes minimum.

Additionally, there is provided a driving method for an optical modulator, comprising the steps of: varying a pulse width of a data signal used for modulating input light; and adjusting a phase difference between the clock signal and the data signal based on light output power of the optical modulator in a state that the pulse width is varied in such a manner that the phase difference becomes minimum.

### BRIEF DESCRIPTION OF THE DRAWINGS

FIG. 1 is a block diagram schematically showing an optical modulator and a main part of a driving circuit thereof according to a first embodiment of the present invention;

FIG. 2A is a diagram showing an example of a clock signal (40 GHz, RZ signal) according to the first embodiment;

FIG. 2B is a diagram showing an example of a data signal (40 GHz, NRZ signal) according to the first embodiment;

FIG. 2C is a diagram showing an example of a light output according to the first embodiment;

FIG. 3A is a diagram illustrating an optical output waveform when phases of the clock signal and the data signal at the optical modulator of the first embodiment are not optimal phases;

FIG. 3B is a diagram illustrating an optical output waveform when phases of the clock signal and the data signal at the optical modulator of the first embodiment are optimal phases;

FIG. 4A is a diagram illustrating an optical output waveform when the pulse width of the data signal at the optical modulator of the first embodiment is a standard pulse width;

FIG. 4B is a diagram illustrating an optical output waveform when the phase difference between the clock signal and the data signal at the optical modulator according to the first embodiment is one-half of the period of the data signal and the pulse width of the data signal is broader than the standard pulse width;

FIG. 4C is a diagram illustrating an optical output waveform when the phase difference between the clock signal and the data signal at the optical modulator according to the first embodiment is one-half of the period of the data signal and the pulse width of the data signal is narrower than the standard pulse width;

FIG. 5 is a diagram showing calculating values of light output average power to various data pulse widths using the phase difference between the clock signal and the data signal as parameters;

FIG. 6 is a block diagram schematically showing a variation amount measurement circuit of FIG. 1;

FIG. 7 is a block diagram schematically showing a pulse width varying circuit of FIG. 1;

FIG. 8A is a diagram showing an output of an oscillator of a delay controlling section of FIG. 1;

FIG. 8B is a diagram showing a variation in data pulse at the pulse width varying circuit shown in FIGS. 1 and 7;

FIG. 9 is a block diagram schematically showing a controlling circuit shown in FIG. 1;

FIG. 10 is a time chart explaining an operation performed in the controlling circuit (a minimum value controlling circuit) shown in FIG. 9;

FIG. 11 is a time chart explaining an operation performed in the controlling circuit (a maximum value controlling circuit) shown in FIG. 9;

FIG. 12A is an interpolator-type phase varying circuit according to the first embodiment;

FIG. 12B is a diagram showing clock signals that are to be input to the phase varying circuit shown in FIG. 12B;

FIG. 13 is a block diagram schematically showing an optical modulator and a main part of a driving circuit thereof according to a second embodiment of the present invention;

FIG. 14 is a block diagram schematically showing a modification of the delay controlling section shown in FIG. 1;

FIG. 15A is a diagram showing an output of an oscillator shown in FIG. 14;

FIG. 15B is a diagram showing an output of π/2 delay circuit shown in FIG. 14;

FIG. 15C is a diagram showing variation in a data pulse width in the pulse width varying circuit shown in FIG. 1;

FIG. 16 is a block diagram schematically showing a modification of the delay controlling section shown in FIG. 1;

FIG. 17 is a block diagram schematically showing the optical modulator shown in FIGS. 1 and 13; and

FIG. 18 is a block diagram schematically showing a conventional optical modulator for generating an RZ signal and a main part of a driving circuit thereof.

### DESCRIPTION OF THE PREFERRED EMBODIMENT

[A] First Embodiment

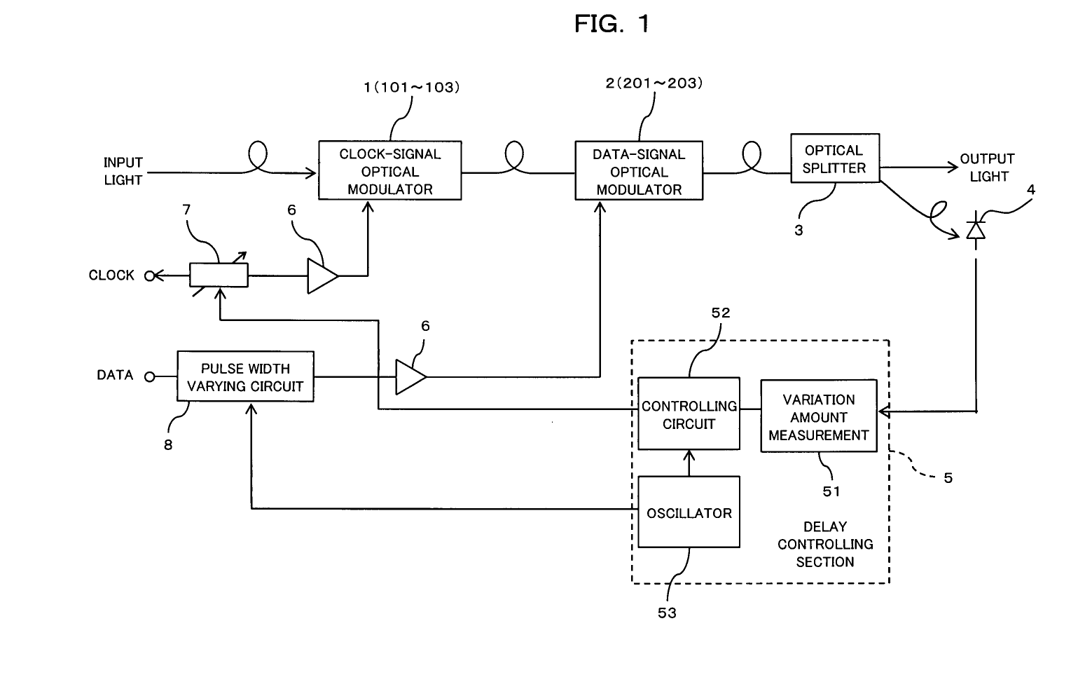

FIG. 1 is a block diagram schematically showing an optical modulator and the main part of a driving circuit thereof according to the first embodiment of the present invention. The optical modulator shown in FIG. 1 includes a Mach-Zehnder optical modulator (hereinafter called a clock modulator) 1 for a clock signal (CLK), a Mach-Zehnder optical modulator (hereinafter called a data modulator) for a data signal (DATA), and an optical splitter 3. The driving circuit includes a photodiode 4, a delay controlling section 5, amplifiers 6, a variable delay circuit 7 and pulse width varying circuit 8.

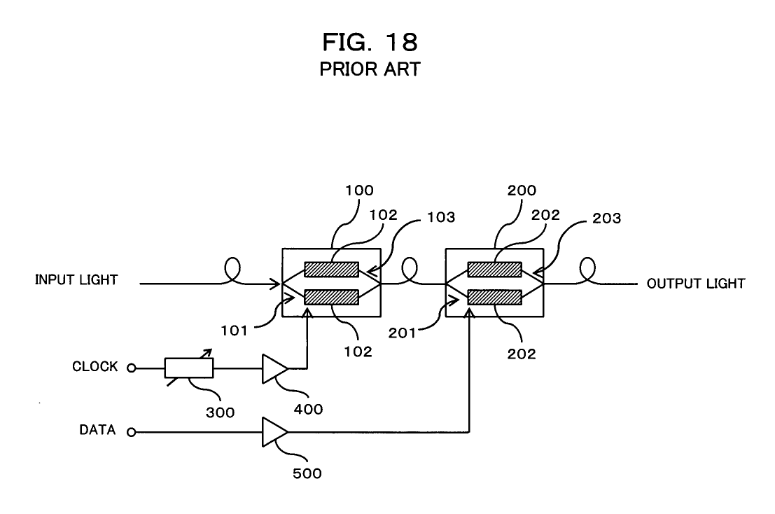

The clock modulator 1 and data modulator 2 are identical or similar to those explained above with reference to FIG. 18. The clock modulator 1 includes an input-side Y-shaped waveguide 101, electrodes 102 and an output-side Y-shaped waveguide 103, and modulates input light using a clock signal which is input to one of electrodes 102 through the variable delay circuit 7 and the amplifier 6. The data modulator 2 includes an input-side Y-shaped waveguide 201, electrodes 202 and an output-side Y-shaped waveguide 203, and modulates a light clock signal which is received from the clock modulator 1, using a data signal which is supplied to one electrode 202 through the pulse width varying circuit 8.

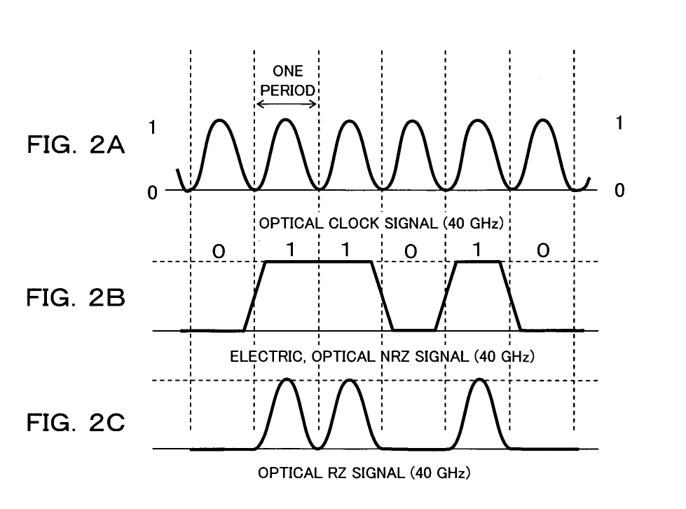

For example, assuming that a clock signal is an RZ signal having a frequency of 40 GHz and a waveform shown in FIG. 2A and that a data signal is a NRZ signal having a frequency of 40 GHz and a waveform shown in FIG. 2B, a light output (40 GHz, an optical RZ signal) having a waveform shown in FIG. 2C is obtained as an output of the data modulator 2.

The variable delay circuit 7 adjusts a relative phase (a phase difference) between a clock signal and a data signal by varying a delay amount of the clock signal. The pulse width varying circuit 8 periodically varies a pulse width of a data signal that is to be supplied to the data modulator 2 in accordance with an output of an oscillator 53 that is to be described later and that is included in the delay controlling section 5. The output of the oscillator 53 is also supplied as an operational clock (clock frequency). Namely, the oscillator 53 is commonly used by the pulse width varying circuit 8 and the controlling circuit 52. A dedicated oscillator may, however, be prepared for each of the pulse width varying circuit 8 and the controlling circuit 52, of course. The amplifiers 6 respectively amplify a clock signal and a data signal to predetermined levels.

Here, description is to be made in order to explain the value of variation in pulse width of a data signal carried out by the pulse width varying circuit 8 as described above.

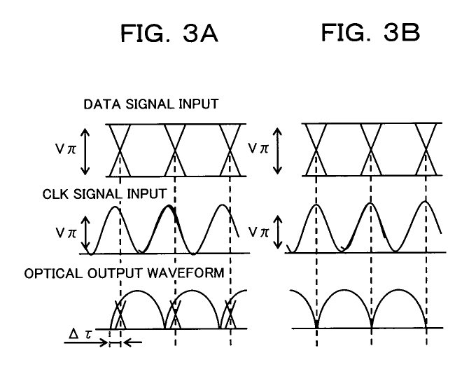

As shown in FIG. 3B, when the phase difference between CLK and DATA is optimum, a waveform of a light output does not deteriorate because a cross point of the data signal coincides with a light extinction time point of a clock signal. Conversely, as shown in FIG. 3A, when the phase difference between CLK and DATA is not optimum, a waveform of a light output deteriorates because a cross point of the data signal departs from a light extinction time point. In FIGS. 3A and 3B, Vπ stands for voltage values supplied to the clock modulator 1 and the data modulator 2 as a clock signal and a data signal respectively.

Assuming that a CLK-DATA phase difference Δτ approximately is equal to T0/2 (T0 represents one cycle of DATA) and that a pulse width (hereinafter called a data pulse width) of the data signal is a width other than a standard pulse width (not equal to 100%), a waveform of light output from the data modulator 2 varies in accordance with the pulse width.

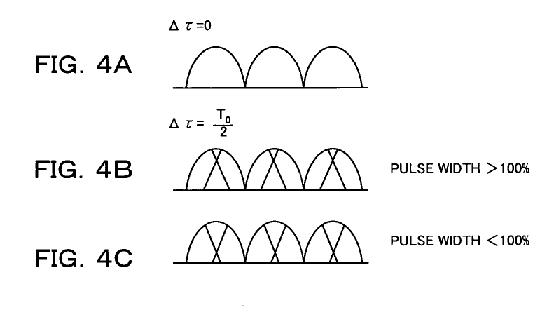

For example, if the data pulse width is set broader (>100%) than a standard pulse width, a cross point of the data signal upwardly shifts, as schematically shown in FIG. 4B, as compared to the cases shown in FIGS. 3A and 3B, so that light output power of the data modulator 2 increases. On the other hand, if the data pulse width is set narrower (<100%) than a standard pulse width, a cross point of the data signal downwardly shifts, as shown in FIG. 4C, when compared to the cases shown in FIGS. 3A and 3B, so that light output power of the data modulator 2 decreases.

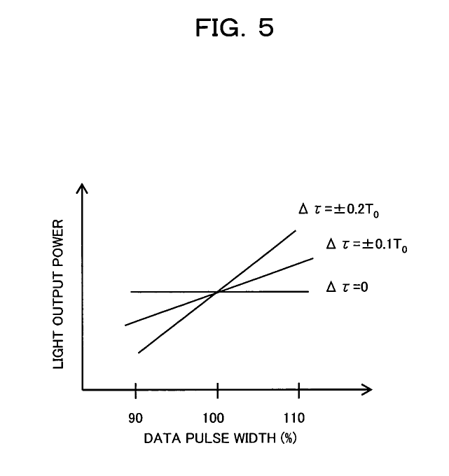

Conversely, under a phase difference Δτ equal to or approximately equal to zero (Δτ=0 or Δ≈0), a cross point of the data signal coincides with a light extinction time point of a clock signal, a deviation of a data pulse width is scarcely observed as schematically shown in FIG. 4A. The above relationship is shown in FIG. 5. FIG. 5 shows calculating values of light output average power to various data pulse widths using the phase difference between the clock signal and the data signal as parameters. As shown in FIG. 5, since no deviation in data pulse width appears on a waveform of a light output at a phase difference Δπ equal to or approximately equal to zero (Δπ=0 or Δτ≈0), light average power does not vary; and a deviation of a data pulse width can be observed on a waveform of a light output at a phase difference not equal to zero (Δτ≠0) whereupon a light output power varies in accordance with the deviation of a pulse width similarly to a light average power of a normal NRZ signal.

On the basis of the relationship of FIG. 5, if a delay amount of the variable delay circuit 7 is set to a value that results in the minimum variation amount of the light output power when a data pulse width is shifted from 100%, it is possible to adjust a relative phase between a clock signal and a data signal to an optimum phase. Additionally, approximating a variation amount of light output power to zero by periodic variation of a data pulse width can also adjust a relative phase between a clock signal and a data signal to an optimum phase.

For this reason, a data pulse width is varied by the pulse width varying circuit 8 and at the same time a part of an output of the data modulator 2 is diverged by the optical splitter 3, and the diverged light is received by the photodiode (light receiving element) 4, which outputs an electric current value in accordance with the amount of the received light which value serves as a monitor signal for light output power to the delay controlling section 5. Subsequently, the delay controlling section 5 measures a variation amount of the monitor signal (light output power) and controls a delay amount in the variable delay circuit 7 in such a manner that a measured variation amount becomes minimum.

In order to accomplish the above operation, the delay controlling section 5 includes, for example, a variation amount measuring circuit 51 for measuring a variation amount of a monitor signal, and a controlling circuit 52 for controlling a delay amount of the variable delay circuit 7 in such a manner that a variation amount of a monitor signal, which amount has been measured in the variation amount measuring circuit 51, becomes minimum, and the oscillator 53 for periodically varying (extending/shortening) a pulse width of the data signal in the pulse width varying circuit 8.

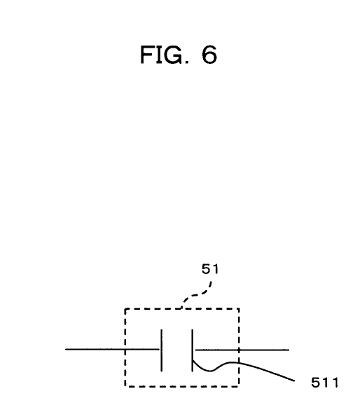

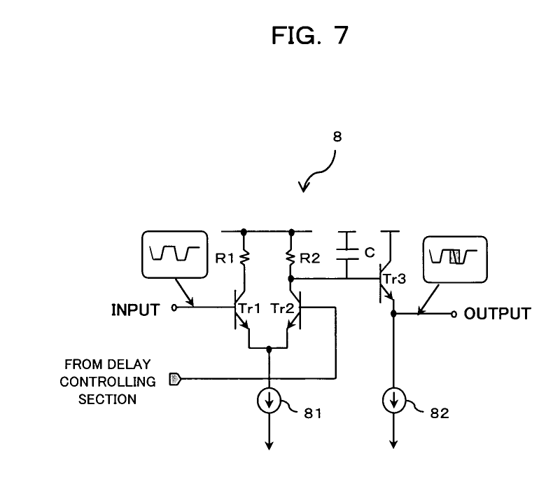

Here, the variation amount measuring circuit 51 may, for example, take the form of a differential measurement circuit that differentiates the above monitor signal to obtain an inclination of a straight line shown in FIG. 5 using a capacitor 511 as shown in FIG. 6. The pulse width varying circuit 8 may be publicly known. Alternatively, the pulse width varying circuit 8 may be, as shown in FIG. 7 for example, formed by a differential logic circuit in which an electric current source 81 is connected to a common emitter of transistor Tr1 and Tr2 and resistors R1 and R2 are respectively connected to collectors of the transistors Tr1 and Tr2, a capacitor C that is connected in parallel to the collector of the transistor Tr2, and a transistor Tr3 the base of which is connected to the collector of the transistor Tr2 and the emitter of which is connected to the electric power source 82.

With such a structure, adjustment to a base voltage of the transistor Tr2 in accordance with a signal from the delay controlling section 5 (the oscillator 53) varies relative voltages appearing at the transistors Tr1 and Tr2. Since a base voltage of the transistor Tr3 varies in response to the variation in the relative voltages, it is possible to shift a cross point of an input data pulse from a standard data pulse (e.g., in a state that the relative voltages are zero) and to thereby extend/shorten a data pulse width.

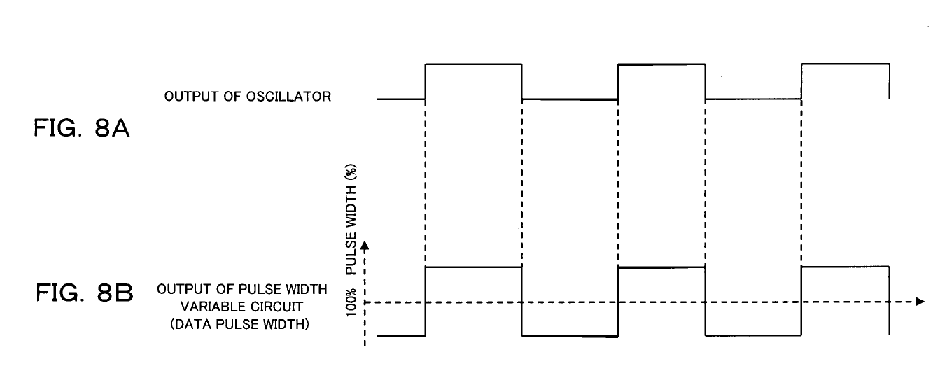

For example, an output waveform of the oscillator 53 assumed to be that shown in FIG. 8A causes an output from the pulse width varying circuit 8 to that shown in FIG. 8B. In other words, the data pulse width is extended at an H-level section in a waveform shown in FIG. 8A and is shortened at an L-level. The capacitor C takes a role in cutting noise components (direct current component) of a data pulse appears in the collector of the transistor Tr2.

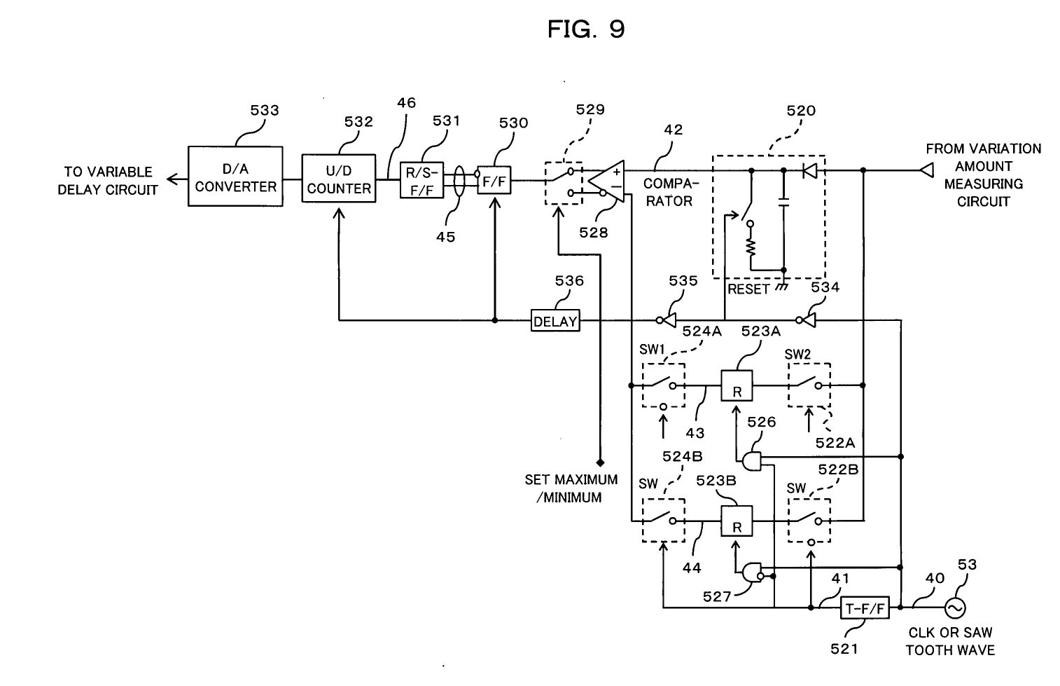

Next, for example as shown in FIG. 9, the controlling circuit 52 (minimum/maximum value controlling circuit) includes a sample and hold circuit 520 having a reset, a T (Toggle) flip-flop circuit 521, switch circuits 522A, 254B and 529, switch circuits 522B and 524A each having an inverter, registers 523A and 523B, an AND circuit 526, an AND (logical product) circuit 527 of one input converting type, a comparator 528, a flip-flop circuit 530, R/S flip-flop circuit 531, up-down (U/D) counter 532, a digital/analog (D/A) converter 533, inverters 534 and 535, a delay circuit 536 and the like.

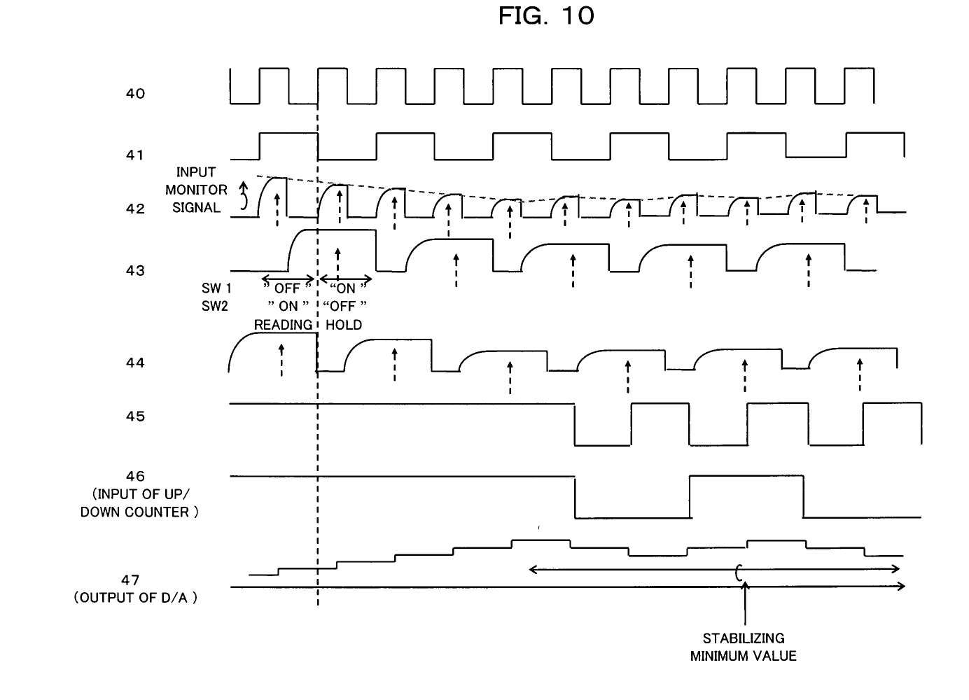

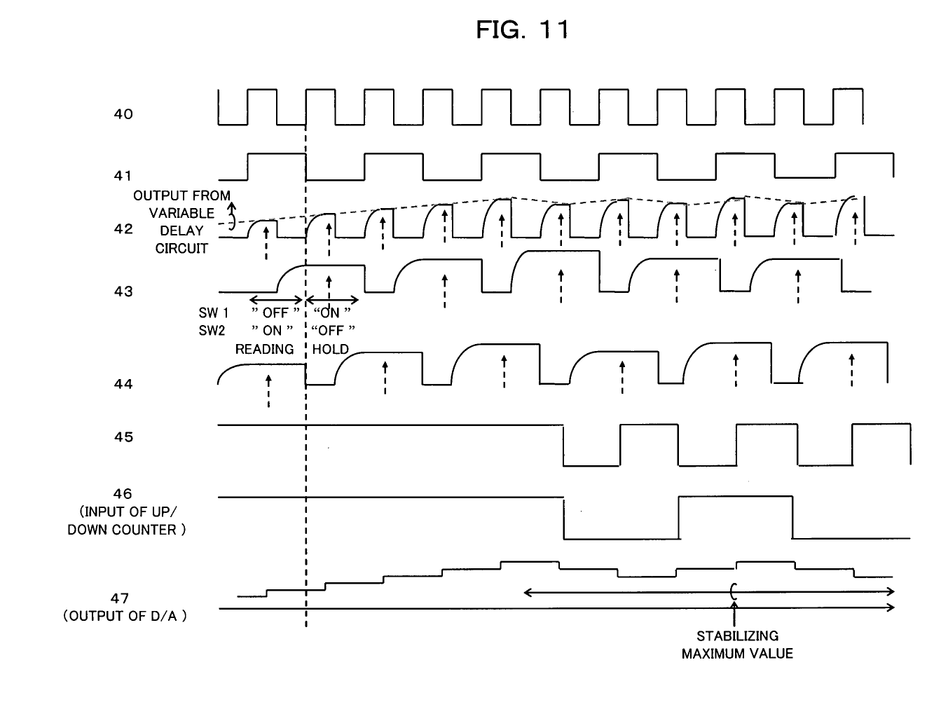

Changeover using the switch 529 causes the controlling circuit 52 to serve as a minimum value controlling circuit or a maximum value controlling circuit. For example, the connecting state of the switch 529 shown in FIG. 9 causes the controlling circuit 52 to serve as a minimum value control circuit, which carries out an operation shown in FIG. 10; and the contrary connecting state of the switch 529 causes the controlling circuit 52 to serve as a maximum value controlling circuit, which performs an operation shown in FIG. 11.

Signals shown in FIGS. 10 and 11 represent an output signal 40 of the oscillator 53, an output signal 41 from the T flip-flop circuit 521, an output signal from the sample and hold circuit 520, an output signal 43 from the register 523A, an output signal 44 from the register 523B, an input signal 45 to the R/S flip-flop circuit 531, an input signal 46 to the up/down counter 532 (an output signal from the R/S flip-flop circuit 531) and an output signal (a delay controlling signal) 47 from the D/A converter 533 in numerical order.

As can be seen with reference to FIGS. 9 and 10, the comparator 528 compares a measurement result of measurement performed by the variation amount measuring circuit 51 (the differential measurement circuit ) which result is held at a clock cycle by the sample and hold circuit 520 and a measurement result of past measurement performed by the variation amount measuring circuit 51 which result is alternatively written at respective different cycles into the registers 523A and 523B and alternatively read at respective different cycles by the switch circuit 522A and 524B and the switch circuits 524A and 524B.

Then the count of the up/down counter 532 increases and decreases in accordance with a result of comparison and an output signal (level) from the D/A converter 533 is increased or decreased, so that the measurement result of the variation amount measuring circuit 51 is stabilized at a value that the measurement result becomes minimum or maximum. As an alternative, function of the above-described controlling circuit 52 may be realized by a publicly known dithering circuit.

With the above-mentioned structure, the optical modulator of the first embodiment periodically varies a pulse width of a data signal from the data signal and a clock signal, which are used for modulating input light, using the oscillator 53 and the pulse width varying circuit 8 and, in this state, the controlling circuit 52 controls a delay amount of the variable delay circuit 7 in such a manner that a variation amount of light output power which amount measured by the variation amount measuring circuit 51 becomes minimum (i.e., in such a manner that the inclination of a straight line shown in FIG. 5 becomes minimum).

As a result, a cross point of the data signal can coincide with a light extinction time of the clock signal so that a relative phase between the clock signal and the data signal becomes an optimum phase whereupon it is possible to stably obtain a fine light output waveform.

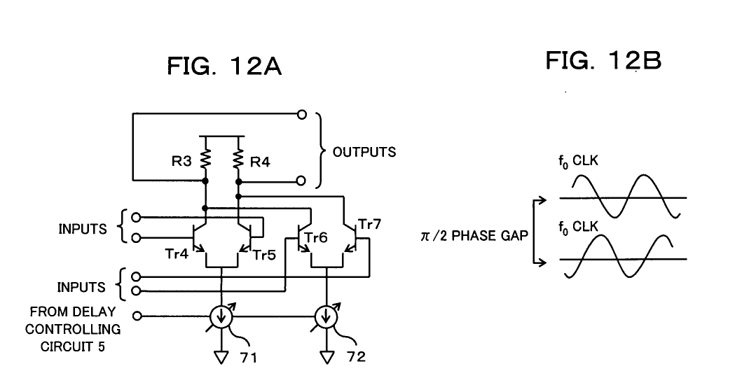

In substitution for the above-described variable delay circuit 7, it is possible to use an interpolator-type phase shifting circuit, as shown in FIGS. 12A and 12B, which includes differential pair transistors Tr4 and Tr5, differential pair transistors Tr6 and Tr7, resistors R3 and R4 respectively connected to collectors of the transistors Tr4 and Tr5, a variable electric current source 71 connected to a common emitter of the transistors Tr4 and Tr5, and variable electric current source 72 connected to a common emitter of the transistors Tr6 and Tr7 and in which clock signals having phases shifted as much as π/2 in relation to each other are regarded as base inputs to transistors Tr4 and Tr5 and the transistors Tr6 and Tr7. Since such a phase shifting circuit supports a broad variation amount of a phase, it is possible to adjust a phase between a clock signal and a data signal in a broader range than that supported by a general variable delay circuit 7.

[B] Second Embodiment

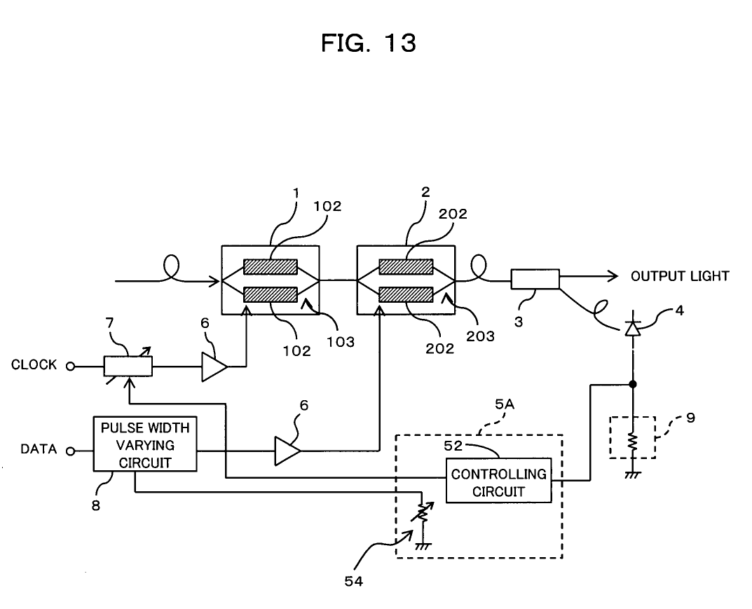

FIG. 13 is a block diagram schematically showing an optical modulator and a main part of the driving circuit thereof according to a second embodiment of the present invention. The optical modulator shown in FIG. 13 has, as compared with that shown in FIG. 1, a controlling circuit 5A in substitution for the delay controlling section 5 and an electric-current/voltage (I/V) converting circuit 9, and is different in that it has no need for a variation amount measuring circuit 51 in the controlling circuit 5A and in installation of a pulse width setting circuit 54 from the delay controlling section 5. Other elements and parts with reference numbers already described are identical to or substantially identical to those described above.

Here, the pulse width setting circuit 54 fixedly sets a pulse width of a data signal supplied to the data modulator 2 to a width other than a standard pulse width in the pulse width varying circuit 8; and the I/V converting circuit 9 converts an electric current value generated in accordance with an amount of light received by the photodiode 4 to a voltage value.

Namely, in the second embodiment, the pulse width setting circuit 54 and the pulse width varying circuit 8 stably extend or shorten a data pulse width to a width (a data pulse width ≠100%) other than a standard width and the controlling circuit 52 controls a delay amount of a clock signal in the variable delay circuit 7 in such a manner that a light output level which is monitored in this state becomes minimum or maximum.

Specifically, on the basis of characteristic features shown in FIG. 5, if the pulse width setting circuit 54 sets (extends) the data pulse width broader than 100%, the controlling circuit 52 serves as a minimum value detecting circuit (see FIG. 10) similarly to the first embodiment; and conversely, if the pulse width setting circuit 54 sets (shortens) the data pulse width narrower than 100%, changeover of the switch circuit 529 shown in FIG. 9 causes the controlling circuit 52 to serve as a maximum value detecting circuit (see FIG. 11).

With this structure, it is possible to always adjust a phase between a clock signal and a data signal to an optimum phase similarly to the first embodiment. Especially, since the second embodiment does not require a variation amount measuring circuit 51, and it is possible to simplify the delay controlling section 5A as compared with the first embodiment.

Further, the second embodiment can also use an interpolator-type phase shifting circuit, which has been described with reference to FIG. 12, as a variable delay circuit 7.

[C] Modification

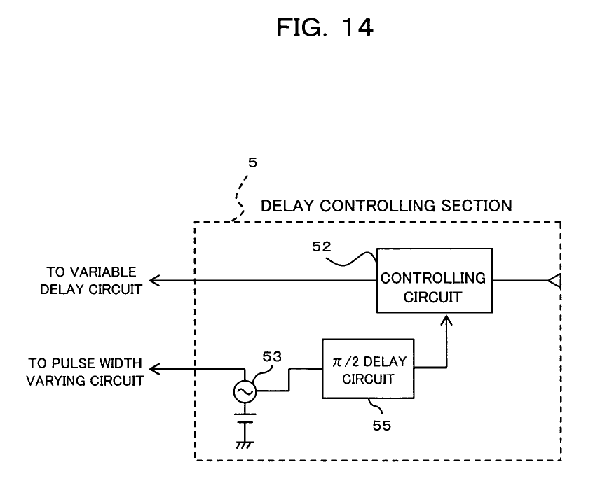

FIG. 14 is a block diagram schematically showing a modification of the delay controlling section 5, which is described in the first embodiment. In the delay controlling section 5 of FIG. 14, an output from the oscillator 53 is input to the controlling circuit 52 via a π/2 delay circuit 55 in addition to the pulse width varying circuit 8, which is a different point.

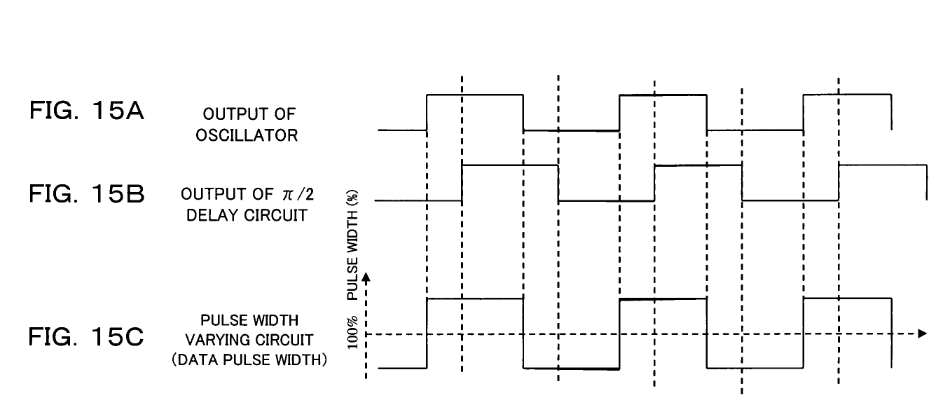

Namely, in this modification, the controlling circuit 52 in the delay controlling section 5 synchronizes detection of a minimum value or a maximum value with a signal (a variation period of a pulse width) shifted by π/2 in relation to an output of the oscillator 53 as shown in FIGS. 15A, 15B and 15C and controls an amount of delay of the variable delay circuit variable delay circuit 7 in such a manner that light output power at a particular pulse width (broader or narrower than 100%) becomes minimum or maximum. A phase between a clock signal and a data signal can be thereby adjusted to an optimum phase. This manner can also obtain the same result as the first embodiment.

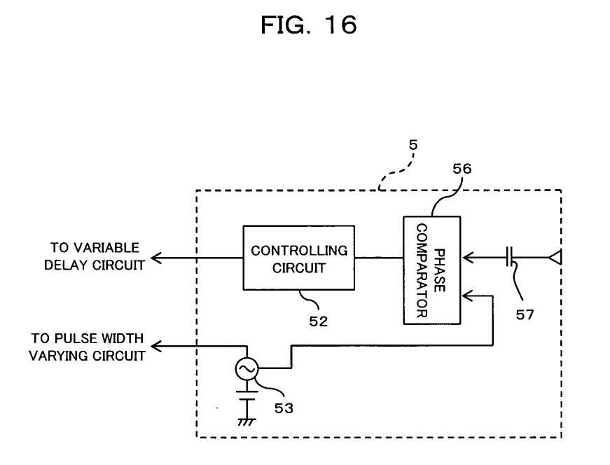

Besides, as shown in FIG. 16 for example, a phase comparator (a power detector) 56 which reverses polarity of gains of a monitor signal in synchronization with an output from the oscillator 53 is installed in the preceding position of the controlling circuit 52 and a delay amount of the variable delay circuit 7 is controlled in such a manner that light output power becomes minimum or maximum at a particular pulse width (broader or narrower than 100%), so that it is possible to always adjust a phase between a clock signal and a data signal to an optimum phase. In FIG. 16, the element with reference number 57 represents the capacitor that takes a role in cutting noise components (direct current component) of a monitor signal.

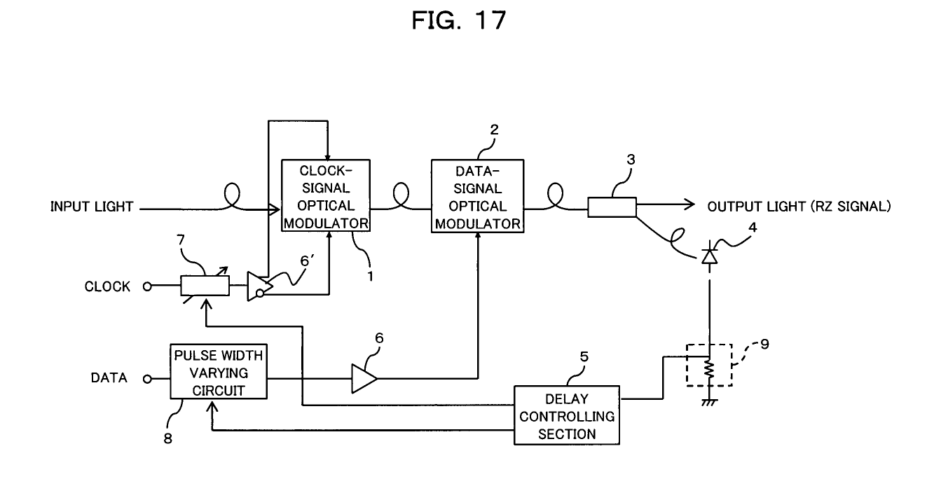

Further, it is possible to adjust a phase between a clock signal and a data signal to an optimum phase if CS (Carrier Suppressed)-RZ modulation method (see Japanese Patent Laid-open No. 2001-119344) in which a clock signal and an inverted signal thereof are input (differentially input) into the clock modulator 1 (electrodes 102) via an amplifier 6 of one output inverting type to obtain a light output signal in an RZ format is adopted as a modification of the clock modulator 1 for example as shown in FIG. 17.

When a clock signal is differentially input into each electrode 102 of the clock modulator 1 as in the above method, a bit rate required for the clock signal can halve as compared to structures shown in FIGS. 1 and 13 (e.g., if an RZ signal of 40 Gbps is desired, a clock signal is enough to have a bit rate of 20 Gbps). Namely in this case, the clock modulator 1 receives a differential signal having a one-half bit rate of a data signal and modulates input light in accordance with the received differential signal.

Further, the present invention can apply to an optical modulator (see Japanese Patent Laid-open No. HEI 5-224163) which differentially inputs a data signal into each electrode 202 of the data modulator 2. Of course, the present invention can also apply to an optical modulator in which a clock modulator 1 and a data modulator 2 are integrated into one body.

The control over the variable delay circuit 7 (phase adjustment) by the above-mentioned delay controlling section 5 (5A) does not have to be carried out all the time, but may be intermittently carried out upon receipt of a timer signal from a non-illustrated external timer. In this case, switches are disposed between the delay controlling section 5 (5A) and the variable delay circuit 7 and between the delay controlling section 5 (5A) and pulse width varying circuit 8 so that the timer signal halts supplying a signal to the variable delay circuit 7 and the pulse width varying circuit 8. Alternatively, control of the timer signal over the D/A converter 533 in the controlling circuit 52 may halt supplying a signal from the controlling circuit 52 to the variable delay circuit 7.

Still further, a phase between a clock signal and the data signal is adjusted by controlling a delay amount of a clock signal with the variable delay circuit 7 arranged on a clock signal line in the above example. As an alternative, a variable delay circuit 7 arranged on a data signal line to control a delay amount of a data signal can realize phase adjustment as in the above example. Additionally, the variable delay circuit 7 can be arranged in any position as long as the position is between a signal source and the optical modulator.

As mentioned above, the present invention intentionally varies pulse width of a data signal used for modulating input light and controls based on light output power of the optical modulator in this state such that the phase difference between a clock signal and a data signal becomes minimum. It is therefore possible to adjust a phase between the clock signal and the data signal to an optimum phase at low cost. As a result, a fine waveform of light output can be stably obtained and highly reliable optical communication can be realized at low cost. For this reason, the present invention is considered to be extremely worthwhile.

1. A driving circuit for an optical modulator for modulating input light using a clock signal and a data signal respectively, comprising:
a variable delay circuit for adjusting a phase difference between the clock signal and the data signal;
a pulse width varying circuit for varying a pulse width of the data signal used for modulating the input light; and
a delay controlling section for controlling said variable delay circuit based on light output power of the optical modulator in a state that said pulse width varying circuit varies the pulse width in such a manner that the phase difference becomes minimum.

2. A driving circuit for an optical modulator according to claim 1, wherein said delay controlling section comprises:
an oscillator for periodically varying the pulse width in said pulse width varying circuit;
a variation amount measuring circuit for measuring a variation amount of light output power of the optical modulator in a state that the pulse width is periodically varied by said oscillator;
a minimum value controlling circuit for controlling said variable delay circuit in such a manner that the variation amount measured by said variation amount measuring circuit becomes a minimum.

3. A driving circuit for an optical modulator according to claim 2, wherein said variation amount measuring circuit is formed by a differential measuring circuit that measures the variation amount by differentiating the light output power of the optical modulator.

4. A driving circuit for an optical modulator according to claim 1, wherein said delay controlling section includes:
a pulse width setting circuit for setting the pulse width to a width other than a standard pulse width in said pulse width varying circuit; and
a minimum/maximum value controlling circuit for controlling said variable delay circuit in such a manner that the light output power of the optical modulator becomes minimum or maximum in a state that the pulse width is set to the width other than the standard pulse width by said pulse width setting circuit.

5. A driving circuit for an optical modulator according to claim 4, wherein said pulse width setting circuit sets the pulse width broader than the standard pulse width in said pulse width variable circuit, and said minimum/maximum value controlling circuit controls said variable delay circuit in such a manner that the light output power of the optical modulator becomes minimum in a state that the pulse width is set broader than the standard pulse width by said pulse width setting circuit.

6. A driving circuit for an optical modulator according to claim 4, wherein said pulse width setting circuit sets the pulse width narrower than the standard pulse width in said pulse width variable circuit, and said minimum/maximum value controlling circuit controls said variable delay circuit in such a manner that the light output power of the optical modulator becomes maximum in a state that the pulse width is set narrower than the standard pulse width by said pulse width setting circuit.

7. A driving circuit for an optical modulator according to claim 1, wherein said delay controlling section comprises:
an oscillator for periodically varying the pulse width at said pulse width varying circuit;
a minimum/maximum value controlling circuit for controlling said variable delay circuit in synchronization with a variable period of the pulse width based on an output of said oscillator in such a manner that the light output power of the optical modulator at a particular pulse width other than a standard pulse width becomes minimum or maximum.

8. A driving circuit for an optical modulator according to claim 7, wherein said minimum/maximum value controlling circuit controls said variable delay circuit in such a manner that the light output power when the pulse width is broader than the standard pulse becomes minimum.

9. A driving circuit for an optical modulator according to claim 7, wherein said minimum/maximum value controlling circuit controls said variable delay circuit in such a manner that the light output power when the pulse width is narrower than the standard pulse becomes maximum.

10. A driving circuit for an optical modulator according to claim 1, wherein said variable delay circuit is an interpolator-type phase shifting circuit.

11. A driving circuit for an optical modulator according to claim 1, wherein said delay controlling section controls intermittently said variable delay circuit in accordance with a timer signal from an external timer.

12. A driving circuit for an optical modulator according to claim 1, wherein:
said optical modulator includes a clock-signal Mach-Zehnder optical modulator for modulating the input light using the clock signal and a data-signal Mach-Zehnder optical modulator for modulating an output of said clock-signal Mach-Zehnder optical modulator using the data signal;
said clock-signal Mach-Zehnder modulator modulates, upon receipt of a differential signal having a one-half bit rate of the data signal, the input light in accordance with the differential signal.

13. A driving circuit for an optical modulator according to claim 12, wherein said clock-signal Mach-Zehnder optical modulator and said data-signal Mach-Zehnder optical modulator are integrated into one body.

14. A method for driving an optical modulator for modulating input light using a clock signal and a data signal respectively, comprising the steps of:
varying a pulse width of the data signal used for modulating the input light; and
adjusting a phase difference between the clock signal and the data signal based on light output power of the optical modulator in a state that the pulse width is varied in such a manner that the phase difference becomes minimum.

15. A method for driving an optical modulator according to claim 14, further comprising the steps of:
periodically varying the pulse width by an oscillator;
measuring a variation amount of light output power of the optical modulator in a state that pulse width is periodically varied by the oscillator; and
adjusting the phase difference in such a manner that the variation amount that has been measured becomes minimum.

16. A method for driving an optical modulator according to claim 14, wherein:
the pulse width is set to a width other than a standard pulse width; and
the phase difference is adjusted in such a manner that the light output power of the optical modulator becomes minimum or maximum in a state that the pulse width is set to the width other than the standard pulse width.

17. A method for driving an optical modulator according to claim 16, wherein:
the pulse width is set broader than the standard pulse width; and
the phase difference is adjusted in such a manner that the light output power of the optical modulator becomes minimum in a state that the pulse width is set broader than the standard pulse width.

18. A method for driving an optical modulator according to claim 16, wherein:
the pulse width is set narrower than the standard pulse width; and
the phase difference is adjusted in such a manner that the light output power of the optical modulator becomes maximum in a state that the pulse width is set narrower than the standard pulse width.

19. A method for driving an optical modulator according to claim 14, wherein:
the pulse width is periodically varied by an oscillator and
the phase difference is adjusted in synchronization with a variable period of the pulse width based on an output of the oscillator in such a manner that the light output power of the optical modulator at a particular pulse width becomes minimum or maximum.

20. A method for driving an optical modulator according to claim 19, wherein the phase difference is adjusted in such a manner that the light output power when the pulse width is broader than the standard pulse width becomes minimum.

21. A method for driving an optical modulator according to claim 19, wherein the phase difference is adjusted in such a manner that the light output power when the pulse width is narrower than the standard pulse width becomes maximum.
